(19) United States
(12) Patent Application Publication
(10) Pub. No.: US 2026/0262558 A1
(43) Pub. Date: Sep. 10, 2026

(54) AGRICULTURAL SYSTEM, AND METHOD FOR OPERATING AN AGRICULTURAL SYSTEM

(71) Applicant: LEMKEN GmbH & Co. KG, Alpen (DE)

(72) Inventors: Sebastian RÖTTGERMANN, Geldern (DE); Stefan HAVERKAMP, Ostbevern (DE); Matthias MÜTER, Bonn (DE)

(73) Assignee: LEMKEN GmbH & Co. KG, Alpen (DE)

(21) Appl. No.: 19/167,182

(22) PCT Filed: Mar. 19, 2024
(86) PCT No.: PCT/DE2024/100230

§ 371 Date: Sep. 19, 2025

(30) Foreign Application Priority Data
Mar. 22, 2023 (DE) 10 2023 106 995.0

(51) Int. Cl. A01B 79/00; A01B 69/04

(52) U.S. Cl. CPC A01B 79/005; A01B 69/008

(57) ABSTRACT

An agricultural system includes a soil cultivation device, a vehicle and a control device. The soil cultivation device has tools arranged on a carrier frame, and a first sensor device and at least one second sensor device. The first sensor device includes a sensor system, arranged on the soil cultivation device, for estimating the speed of a material volume moved by at least one of the tools. The at least one second sensor device includes a sensor system, arranged on the soil cultivation device, for estimating a speed difference between the soil cultivation device and the moved material volume. Depending on the evaluation for estimating an actual operating state, the control device generates control commands in order to visualize an operating state change which deviates from a target operating state and/or to suggest and/or automatically adapt setting parameters, to be changed, of the soil cultivation device and/or of the vehicle.

### CROSS-REFERENCE TO RELATED APPLICATION

This application is a national stage application, filed under 35 U.S.C. § 371, of International Patent Application PCT/DE2024/100230, filed on Mar. 19, 2024, which claims the benefit of German Patent Application DE 10 2023 106 995.0, filed on Mar. 22, 2023.

### TECHNICAL FIELD

The present disclosure relates to an agricultural system and to a method for operating an agricultural system.

### BACKGROUND

An agricultural system is known from EP 4 021 160 A1. The agricultural system comprises a soil cultivation device, a vehicle for moving and driving the soil cultivation device, and a control device. The soil cultivation device has tools arranged in rows one behind the other on a carrier frame, these being able to be brought into engagement with a soil to be cultivated, as well as a first sensor device and at least one second sensor device.

At least one soil cultivation tool in a first row is monitored by means of the first sensor arrangement with regard to the material flow occurring at these soil cultivation tools, and at least one soil cultivation tool in a subsequent row is monitored by means of the second sensor arrangement. Exceeding a threshold value for a difference in material flow between the soil cultivation tool in the first row and the soil cultivation tool in the subsequent row is used by the control device as a criterion to determine whether some of the soil cultivation tools are not positioned in the same plane.

US 2020/0305335 A1 discloses a soil cultivation device with a sensor arranged thereon, which is set up to generate a signal which is an indicator of the occurrence of a blockage. The occurrence of a blockage is determined by comparing the signal with a threshold value stored in a control device.

### SUMMARY

The disclosure is based on the object of refining an agricultural system of the type mentioned at the beginning, which is characterized by preventive actuation of the agricultural system to avoid blockages.

This object is achieved by an agricultural system as disclosed and claimed. Advantageous embodiments and refinements can be found in the dependent claims.

An agricultural system is proposed which comprises a soil cultivation device, a vehicle for moving and driving the soil cultivation devices, and a control device, wherein the soil cultivation device has tools arranged on a carrier frame which can be brought into engagement with a soil to be cultivated, as well as a first sensor device and at least one second sensor device. The first sensor device comprises a sensor system, in particular an imaging and/or optical sensor system, arranged on the soil cultivation device, for estimating the speed of a material volume moved by at least one of the tools in relation to the working width of the soil cultivation device, wherein the at least one second sensor device comprises a sensor system, arranged on the soil cultivation device and detecting an actual speed, for estimating a speed difference between the soil cultivation device and the moved material volume, wherein the control device is set up to receive and evaluate the data generated by the first sensor device and the second sensor device to estimate an actual operating state of the soil cultivation device, and, depending on the evaluation for estimating the actual operating state, the control device generates control commands in order to visualize an operating state change which deviates from the target operating state and/or to suggest and/or automatically adapt setting parameters, to be changed, of the soil cultivation device and/or of the vehicle.

The disclosure is based on the idea that the use of at least two sensor devices characterized by different measuring principles enables differentiating detection of the occurrence of an actual operating state that deviates from a target operating state and is attributable to an impending or existing blockage. The correlation of the data from the first sensor device and the at least one second sensor device is used to infer an impending or existing blockage. This is associated with an automatic reaction by the control device, which consists in visualizing the operating state change deviating from the target operating state and/or suggesting and/or adjusting setting parameters of the soil cultivation device and/or the vehicle. The aim is to detect an impending blockage at an early stage as this may still make it possible to influence the process by changing the settings on the soil cultivation device or the vehicle in such a way that the occurrence of the critical blockage state is avoided. The system also makes it possible to determine whether the detected actual operating state is based on optimal parameterization of the system. The first sensor device is used to estimate the speed of a material volume moved by at least one of the tools and/or a material volume distribution in relation to the working width of the soil cultivation device. The at least one second sensor device is used to detect a speed of the system or a part of the system in order to determine a speed difference between the soil cultivation device and the moved material volume. The speed difference is an essential criterion for estimating the actual operating state.

The system makes it possible to distinguish between different actual operating states: an undisturbed crop flow, a crop flow that is at least partially slowing down, and/or a crop flow that is at least partially interrupted by a blockage. The term “partial” refers to the occurrence of a disturbance on or in front of at least one tool, in relation to the working width of the soil cultivation device.

The control device can be assigned to the soil cultivation device or the vehicle or arranged on it.

In particular, the first sensor device can be arranged in a position above the carrier frame so that its detection area is directed at or can be aligned with the soil in order to detect the space located between the tools arranged at a distance from one another on the carrier frame. For example, the first sensor device can be arranged on the vehicle or on or above a three-point turret on the soil cultivation device. An actuator can be provided to adjust the alignment of the first sensor device. The actuator can be actuated by the control device.

The first sensor device can preferably be set up to detect a material volume distribution in the working area of the soil cultivation device.

The first sensor device can be designed as a radar sensor, a camera, preferably a stereo camera, or a LiDAR sensor. The speed of the material volume moved by at least one of the tools and/or the material volume distribution in relation to the working width of the soil cultivation device can be inferred using the first sensor device. Depending on the design, the first sensor device can comprise at least one sensor.

When designed as a radar sensor, which is directed at the moved material volume, the reflected response signal or measurement noise changes depending on the material flow speed and the amount of moved material in the working area of the soil cultivation device. If specified threshold values are exceeded, this indicates a malfunction.

Scanning the elevation profile of the moved material in the working area using a LiDAR sensor can also indicate an anomaly in the material flow and a build-up of earth. In this case, an ideal profile stored in the control device can be compared with the currently determined elevation profile.

The control device can be set up to take account of boundary conditions which result, for example, from a set soil penetration depth of the tools. A greater depth of soil penetration by the tools is accompanied by an increase in the material volume moved or the material volume distribution which must be taken into account when estimating the actual operating state.

The control device can preferably be set up to divide the material into different categories by evaluating the data provided by the first sensor device. In particular, the control device can categorize the material into the components soil, plant material and dust.

Furthermore, the at least one second sensor device for determining a speed of at least one component of the soil cultivation device rotating upon contact with the soil can be set up. A component of the soil cultivation device rotating upon contact with the soil can in particular be a passively driven component of the soil cultivation device, for example a roller unit, a levelling disc and/or a spur wheel. The at least one second sensor device can comprise at least one sensor.

In particular, the control device can be set up to determine the material volume moved by at least one of the tools by establishing a difference between the material flow speed and the actual speed of the soil cultivation device, the vehicle or the system.

By comparing the actual speed with a pixel-based or marker-based determining the speed of a material volume moved by at least one of the tools in the working area of the soil cultivation device, a “pushing” or build-up of material within the soil cultivation device can be detected. Partially excessive speed differences between the actual speed and the speed of the moved material volume indicate a build-up of material and/or earth material and thus at least a partial “blockage” of the soil cultivation device.

To determine the current driving speed, at least one speed sensor can be arranged on the component of the soil cultivation device that rotates upon contact with the soil and/or a position locating sensor can be arranged on the soil cultivation device. Using a speed sensor on a component of the soil cultivation device that rotates upon contact with the soil, for example the roller unit, the levelling disc and/or the spur wheel, the occurrence of slippage on the rotating component can be detected by comparing it with the actual speed of the soil cultivation device, the vehicle or the system. The occurrence of slippage can be an indicator of an impending blockage, which is evaluated in conjunction with the data from the first sensor device.

Alternatively or additionally, the control device can be set up to determine the actual speed of the soil cultivation device to receive the driving speed of the vehicle. The driving speed of the vehicle can be determined by a position locating sensor on the vehicle or by another sensor arranged on the vehicle, for example a speed sensor on a vehicle wheel or an input shaft of the vehicle transmission.

According to a refinement, the system can additionally have a force-measuring sensor device for estimating changes in a force transmitted by the tools to the soil and/or from the vehicle to the soil cultivation device. A tensile force of the soil cultivation device and/or the tensile force of each individual tool can thereby be determined. For this purpose, force measuring sensors of a coupling device of the vehicle, for example on lower links of a three-point hitch as a coupling apparatus, or strain gauges on a rail shaft of a trailer hitch of the soil cultivation device, can be provided.

Additionally or alternatively, a change in one or more operating parameters of the vehicle can be detected and evaluated to estimate a change in the force transmitted from the vehicle to the soil cultivation device. Operating parameters of the vehicle that are to be monitored may include engine characteristics, transmission parameters or the torque and speed of a PTO shaft if it is coupled to the soil cultivation device to drive it. Engine characteristics may include engine load, fuel consumption or engine power. Transmission parameters may include pressures, torques and/or speeds.

Provision can more preferably be made for the rotational speed of actively driven components of the soil cultivation device to be detected by a speed sensor and transmitted to the control device for evaluation.

In particular, at least a threshold value for a speed difference can be stored in the control device, upon exceeding of which the control device detects an impending or existing blockage.

A change in a tensile force transmitted from the soil cultivation device to the soil may be detectable by monitoring a hydraulic pressure in a cylinder of a hydraulic overload protection device of the soil cultivation device.

According to a preferred refinement, the vehicle can be operated autonomously.

The object posed at the outset is further achieved by a method according to independent Claim 14.

According to independent Claim 14, a method for operating an agricultural system, in particular according to one of Claims 1 to 13, is proposed, comprising a soil cultivation device, a vehicle for moving and driving the soil cultivation device, and a control device, wherein the soil cultivation device has tools arranged on a carrier frame which are brought into engagement with a soil to be cultivated. Estimation of a material volume moved by at least one of the tools in relation to the working width of the soil cultivation device is determined by a first sensor device, in particular an imaging and/or optical sensor device, arranged on the soil cultivation device,
estimation of a speed difference between the soil cultivation device and the moved material volume is determined by at least one second sensor device arranged on the soil cultivation device and detecting an actual speed,
data generated by the first and the second sensor devices for estimating an actual operating state of the soil cultivation device are received and evaluated by the control device, and
depending on the evaluation, control commands are generated by the control device in order to visualize an operating state change which deviates from the target operating state and/or to specify and/or automatically make changes to the setting parameters of the soil cultivation device and/or of the vehicle. Reference should be made to the advantages of the agricultural system according to the disclosure.

The system and the method use data from two mutually independent sensor devices to determine the actual operating state in order to improve the plausibility of the evaluation and the resulting generation of control commands.

In particular, when recording a soil cultivation process, the system can determine initial reference data for the speed of the material volume moved by the tools and the actual speed of the soil cultivation device occurring under the existing conditions, which define the target operating state. For this purpose, an initial system set-up and training process can be carried out to determine reference data for the speed of the material volume moved by the tools and the actual speed of the soil cultivation device. Through appropriate evaluation of the data generated by the first and at least one second sensor device during the set-up and training process, a target operating state can be defined which corresponds to the currently prevailing operating conditions in the agricultural area to be cultivated.

A change in a force transmitted by the tools to the soil and/or from the vehicle to the soil cultivation device can preferably be estimated by an additional force-measuring sensor device. A tensile force of the soil cultivation device and/or the tensile force of each individual tool of the soil cultivation device can hereby be determined. Additionally or alternatively, a change in one or more operating parameters of the vehicle can be detected and evaluated to estimate a change in the force transmitted from the vehicle to the soil cultivation device.

### BRIEF DESCRIPTION OF THE DRAWINGS

The present invention is explained in more detail below using an exemplary embodiment shown in the drawings.

FIG. 1 shows a schematic and exemplary illustration of a soil cultivation device of an agricultural system for soil cultivation;

FIG. 2a shows a schematic and exemplary illustration of tools of the soil cultivation device in a top view in view;

FIG. 2b shows the schematic and exemplary illustration of the tools according to view FIG. 2a in a side view;

FIG. 3a shows a schematic and exemplary illustration according to FIG. 2a with disturbed crop flow

FIG. 3b show the schematic and exemplary illustration of the tools according to FIG. 3a in a side view;

FIG. 4 shows a schematic and exemplary top view of a working area of the tools of the soil cultivation device; and

FIG. 5 shows a simplified schematic and exemplary illustration of a process for evaluating the data provided by a first sensor device.

### DETAILED DESCRIPTION

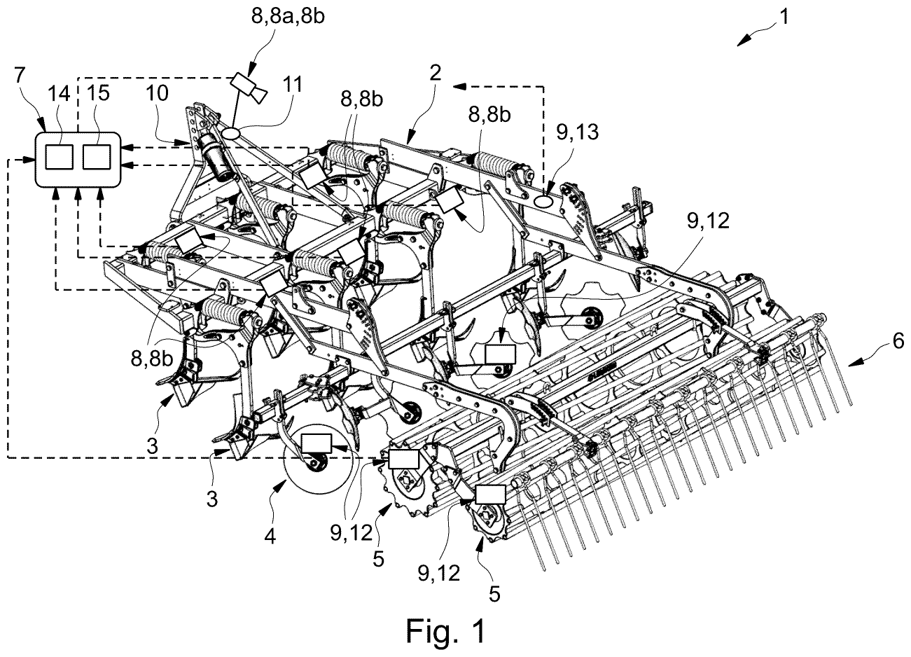

FIG. 1 shows a schematic and exemplary illustration of a soil cultivation device 1 of an agricultural system for soil cultivation. The agricultural system comprises the soil cultivation device 1 and a vehicle (not shown) that moves the soil cultivation device 1. The vehicle can also serve to drive the soil cultivation device 1. In particular, the vehicle can be operated autonomously.

In the exemplary embodiment shown, the soil cultivation device 1 is configured as a cultivator, in particular a tine cultivator. The soil cultivation device 1 can also be configured as a harrow, plough, hoe or the like.

The soil cultivation device 1 has a carrier frame 2. Various tools 3 or components 4, 5, 6 can be arranged on the carrier frame 2. In a front area, blades 3 are arranged as tools which can be brought into engagement with a soil to be cultivated. Edge and levelling discs 4 are arranged side by side on the carrier frame 2 in at least one row downstream of the blades 3. A roller unit 5 is connected to the discs 4, this being configured here, for example, as a pair of double rollers. Harrow tines 6 are attached to the carrier frame 2 downstream of the roller unit 5. The discs 4 and the roller unit 5, as rotating components of the soil cultivation device 1, are driven passively, i.e. they rotate upon contact with the soil of the soil cultivation device 1 pulled by the vehicle.

The illustration in FIG. 1 also shows a control device 7 which can be assigned to the soil cultivation device 1 or the vehicle. The system comprises a first sensor device 8 and at least one second sensor device 9.

The first sensor device 8 comprises at least one sensor system 8a, 8b. The first sensor device 8 can comprise a sensor system configured as a camera 8a, in particular as a stereo camera, which is arranged on the three-point turret 10 of the soil cultivation device 1. Alternatively or additionally, the first sensor device 8 can have at least one sensor system 8b configured as radar sensors or lidar sensors. The first sensor device 8 can also be arranged on a separate holder arranged on the soil cultivation device 1 in order to position it above a level of the carrier frame 2.

The first sensor device 8 and the sensor system 8a configured as a camera are preferably arranged here in a position above the carrier frame 2 so that the detection area of the first sensor device 8 is directed at or can be aligned with the soil to be cultivated in order to detect the space located between the tools 3 arranged at a distance from one another on the carrier frame 2, in particular space located between the tools 3, preferably the blades 3 here, which can be brought into engagement with the soil. The first sensor device 8 can be aligned by means of an actuator 11 in order to adapt the detection area of the first sensor device 8. The actuator 11 can be operated manually or mechanically.

The at least one optional or additional sensor system 8b of the first sensor device 8 can be arranged for this purpose above the tools 3 on the carrier frame 2 or instead of the camera 8a on the three-point turret 10. Several sensor systems 8b can be arranged on a common horizontal plane on the carrier frame 2.

The at least one second sensor device 9 is set up to determine a speed of at least one component rotating upon contact with the soil, here preferably on at least one of the levelling discs 4 and/or the roller unit 5, of the soil cultivation device 1. To determine the actual speed of the soil cultivation device 1, the at least one second sensor device 9 can have at least one sensor system configured as a speed sensor 12 which is arranged on the at least one component of the soil cultivation device 1 rotating upon contact with the soil and/or a position locating sensor 13 which is arranged on the soil cultivation device 1.

Alternatively or additionally, the control device 7 can be set up to determine the actual speed of the soil cultivation device 1 to receive the driving speed of the vehicle. The driving speed of the vehicle can be determined by a position locating sensor on the vehicle or by another sensor system arranged on the vehicle sensor system, which is part of the second sensor device 9, for example a speed sensor on a vehicle wheel or an input shaft of the vehicle transmission.

The first sensor device 8 and the at least one second sensor device 9 are connected to the control device 7 via a wireless and/or wired means of communication for data transmission. The control device 7 comprises a memory unit 14 and a computing unit 15. Evaluation algorithms are stored or can be stored in the memory unit 14 and can be executed by the computing unit 15 to evaluate the data transmitted by the first sensor device 8 and the at least one second sensor device 9.

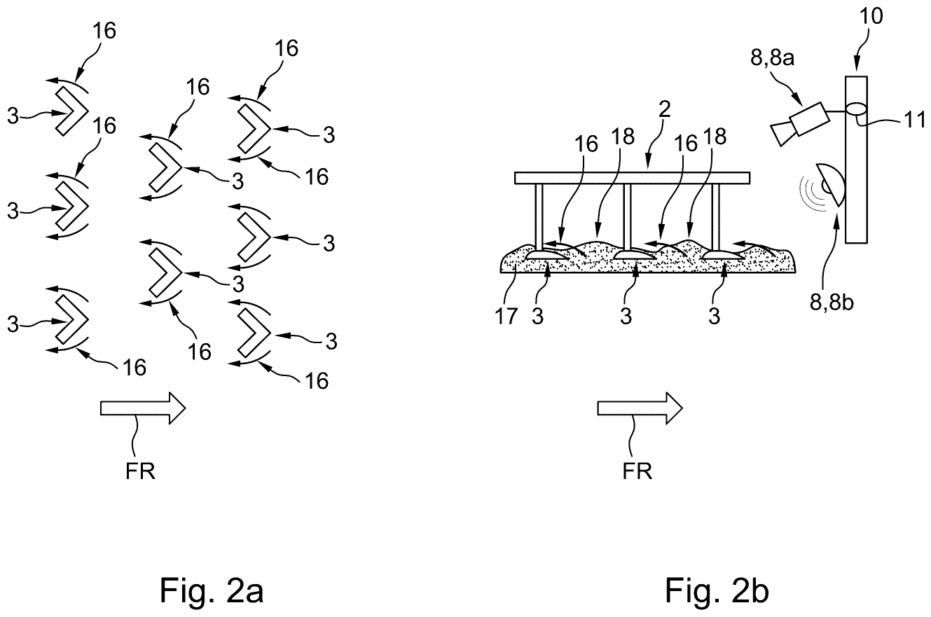

FIG. 2 shows a schematic and exemplary illustration of tools 3 of the soil cultivation device 1 in a top view according to view a) and in view b) the schematic and exemplary illustration of the tools 3 according to view a) in a side view; The illustrations in FIG. 2 show trouble-free operation of the soil cultivation device 1.

The tools 3 of the soil cultivation device 1 which are configured as blades are moved by the vehicle in the direction of travel FR. Reference numeral 16 denotes a material volume moved by the tools 3. The material volume 16 moved in the working area of the soil cultivation device 1 comprises soil material, plant material and dust. In FIG. 2b, the tools 3 are shown engaging with a soil 17 to be cultivated. As can also be seen from the illustration in FIGS. 2a and 2b, the moved material volume 16 is detected by the first sensor device 8. Furthermore, the first sensor device 8 is set up to detect a material volume distribution 18 within the working width of the soil cultivation device 1. In particular, the first sensor device 8 is set up to detect one-sided accumulations or irregularities in the material volume distribution 18.

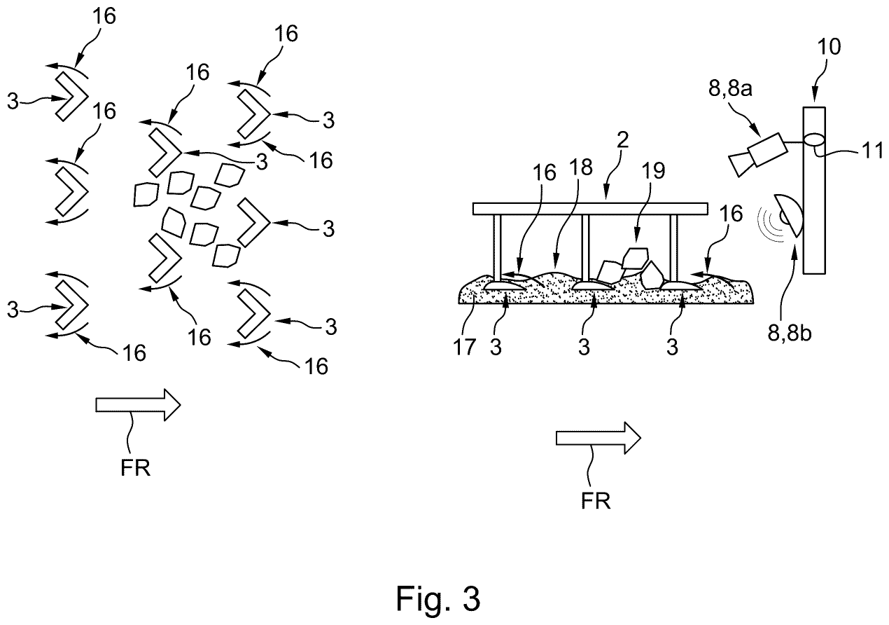

FIG. 3 shows a schematic and exemplary illustration according to FIG. 2a with disturbed crop flow of the material volume 16 in view a) and in view b) the schematic and exemplary illustration of the tools 3 according to view a) in a side view. Reference numeral 19 denotes an imminent or existing blockage by soil material and/or plant material which is impairing the crop flow of the material volume 16 within the soil cultivation device 1 and thus influences the cultivation process.

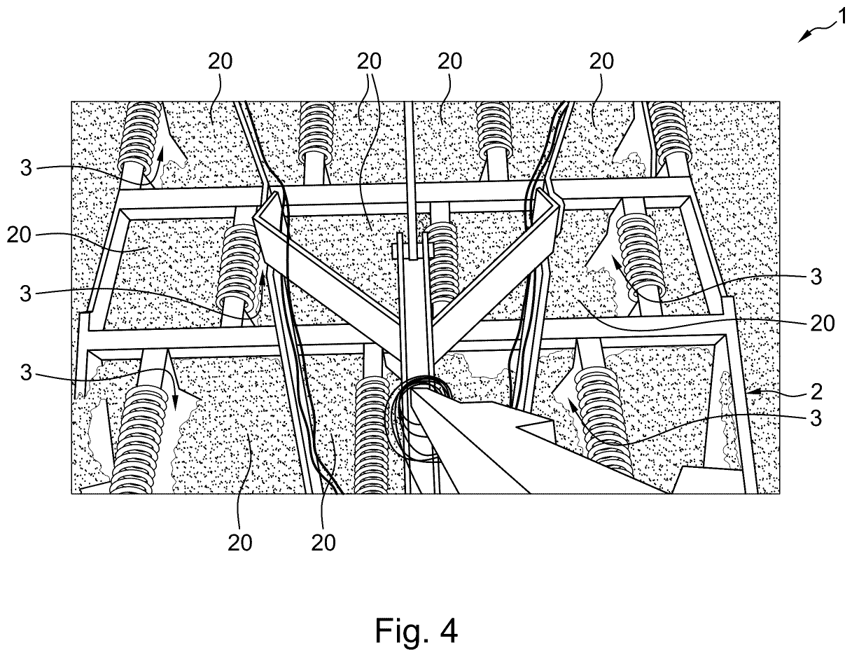

The illustration in FIG. 4 shows a schematic and exemplary top view of a working area of the tools 3 of the soil cultivation device 1. By means of the sensor device 8 arranged on the three-point turret 10, segments 20 forming between the tools 3 are detected in order to determine a locally moved material volume 16 or a local material volume distribution 18. The control device 7 additionally categorizes the material into the components soil, plant material and dust.

The control device 7 is set up to receive and evaluate the data generated by the first sensor device 8 and the at least one second sensor device 9 for estimating an actual operating state of the soil cultivation device 1. To avoid the occurrence of an impending blockage 19, provision is made, depending on the evaluation for estimating the actual operating state, for the control device 7 to generate a control commands in order to visualize an operating state change which deviates from the target operating state and/or to suggest and/or automatically adapt setting parameters, to be changed, of the soil cultivation device 1 and/or of the vehicle. The output for visualizing an operating state change deviating from the target operating state and/or the display of setting parameters of the soil cultivation device 1 and/or the vehicle to be changed can be provided on a control unit of the agricultural system, in particular a control unit of the vehicle. Furthermore, the control unit can be set up for entering and/or selecting setting parameters of the soil cultivation device 1 and/or the vehicle to be changed by an operator of the system.

The system makes it possible to distinguish between different actual operating states: an undisturbed crop flow, a crop flow that is at least partially slowing down, and/or a crop flow that is at least partially interrupted by a blockage. The term “partial” refers to the occurrence of a disturbance on or in front of at least one tool 3, in relation to the working width of the soil cultivation device 1.

Using the speed detected by the at least one speed sensor 12 on a component of the soil cultivation device 1 which rotates upon contact with the soil, for example the roller unit 5, the levelling disc 4 and/or a spur wheel, the occurrence of slippage on the rotating component can be detected by comparing it with the actual speed of the soil cultivation device 1, the vehicle or the system. The occurrence of slippage can be an indicator of an impending blockage. In particular, this can be an indicator of where in the soil cultivation device 1 the blockage is developing or occurring. Either at the levelling discs 4 or at the roller unit 5. In a roller unit 5 with two rollers, the occurrence of slippage can be limited to one of the two rollers, thus limiting the development or occurrence of the blockage in the roller unit 5.

According to a refinement, the system can additionally have a force-measuring sensor device for estimating changes in a force transmitted by the tools 3 to the soil 17 and/or from the vehicle to the soil cultivation device 1. A tensile force of the soil cultivation device 1 and/or the tensile force of each individual tool 3 can thereby be determined. For this purpose, force measuring sensors of a coupling device of the vehicle, for example on lower links of a three-point hitch as a coupling apparatus, or strain gauges on a rail shaft of a trailer hitch of the soil cultivation device, can be provided.

Additionally or alternatively, a change in one or more operating parameters of the vehicle can be detected and evaluated to estimate a change in the force transmitted from the vehicle to the soil cultivation device 1.

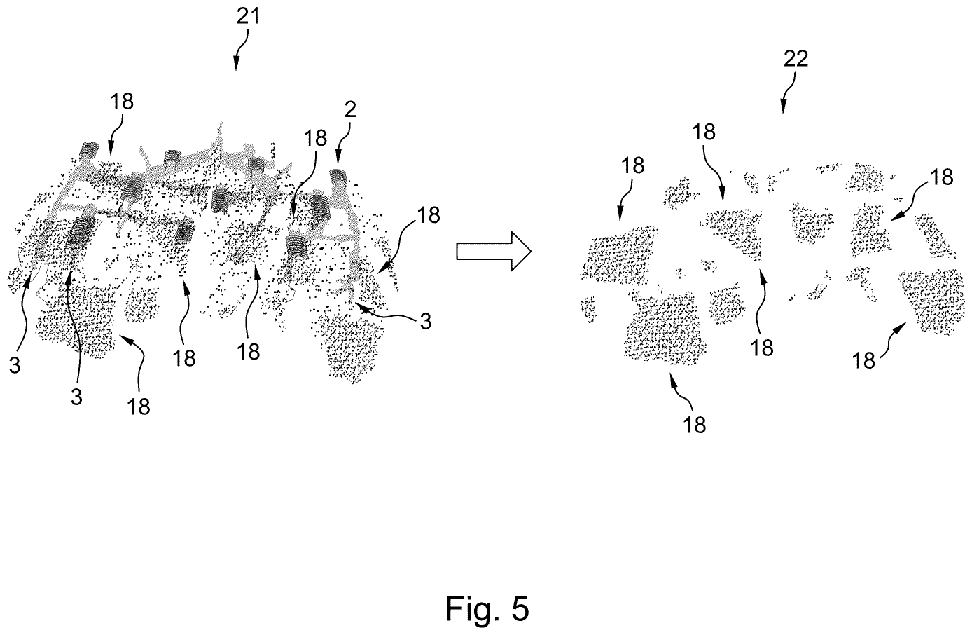

FIG. 5 shows a simplified schematic and exemplary illustration of a process for evaluating the data provided by the first sensor device 8.

For this purpose, images of the working area of the soil cultivation device 1 to be monitored are continuously recorded in the visible wavelength range using the first sensor device 8, which is preferably configured here as a stereo camera 8a, to create a depth estimate. An example of such an image is shown in FIG. 4. The depth estimation is intended to determine the material volume distribution 18 on the surface of the soil 17 to be cultivated in the individual segments 20 between the tools 3 of the soil cultivation device 1.

The control device 7 evaluates the image data by a 3D transformation between the plane of the carrier frame 2 and the plane of the stereo camera 8a using a plane fitting algorithm stored in the memory unit 14. This transformation step results in a point cloud 21 that is essentially reduced to the sensor-monitored working area, as shown on the left in FIG. 5. The point cloud 21 shows the carrier frame 2 and the tools 3 arranged on it, as well as the local material volume distribution 18 in the segments 20 and in the edge area outside the working area of the soil cultivation device 1.

In a further method step, the part of the point cloud 21 which represents the carrier frame 2 is filtered out, resulting in a representation of a point cloud 22 reduced to the local material volume distribution 18, as shown on the right in FIG. 5. The point cloud 22 reduced to the local material volume distribution 18 enables accumulating material to be detected, the working depth to be determined and the type of accumulating material to be derived. Through the continuous detection and evaluation of the image data, the speed of the material volume 16 moved by at least one of the tools 3 is inferred in order to use these data in conjunction with the data provided by the at least one second sensor device 9 on the actual speed of the at least one second sensor device 9 to estimate the actual operating state.

In the control device 7, at least one threshold value is stored for a speed difference resulting from the speed of the material volume 16 moved by at least one of the tools 3 and the actual speed, upon exceeding of which the control device 7 detects an impending or existing blockage.

In particular, when recording a soil cultivation process, the system can determine initial reference data for the speed of the material volume 16 moved by the tools 3 and the actual speed of the soil cultivation device 1 occurring under the existing conditions, which define the target operating state. For this purpose, an initial system set-up and training process can be carried out to determine reference data for the speed of the material volume 16 moved by the tools 3 and the actual speed of the soil cultivation device 1. Through appropriate evaluation of the data generated by the first sensor device 8 and the at least one second sensor device 9 during the set-up and training process, a target operating state can be defined which corresponds to the currently prevailing operating conditions in the agricultural area to be cultivated.

LIST OF REFERENCE NUMERALS

| | |
|---|---|
| 1 | Soil cultivation device |
| 2 | Carrier frame |
| 3 | Tool |
| 4 | Levelling disc |
| 5 | Roller unit |
| 6 | Harrow tines |
| 7 | Control device |
| 8 | First sensor device |
| 8a | Camera/stereo camera |
| 8b | Sensor |
| 9 | Second sensor device |
| 10 | Three-point turret |
| 11 | Actuator |
| 12 | Speed sensor |
| 13 | Position locating sensor |
| 14 | Memory unit |
| 15 | Computing unit |
| 16 | Material volume |
| 17 | Soil |
| 18 | Material volume distribution |
| 19 | Blockage |
| 20 | Segment |
| 21 | Point cloud |
| 22 | Point cloud |
| FR | Direction of travel |

1.-16. (canceled)

17. An agricultural system, comprising:
a soil cultivation device (1);
a vehicle for moving and driving the soil cultivation device (1); and
a control device (7),
wherein the soil cultivation device (1) has
tools (3) which are arranged on a carrier frame (2) and can be brought into engagement with a soil (17) to be cultivated,
a first sensor device (8), and
a second sensor device (9),
wherein the first sensor device (8) comprises a sensor system (8a, 8b) arranged on the soil cultivation device (1), for estimating a speed of a material volume (16) moved by at least one of the tools (3),
wherein the second sensor device (9) comprises a second sensor system (12, 13), arranged on the soil cultivation device (1) and detecting an actual speed, for estimating a speed difference between the soil cultivation device (1) and the material volume (16),
wherein the control device (7) is configured to receive and evaluate data generated by the first sensor device (8) and the second sensor device (9) to estimate an actual operating state of the soil cultivation device (1), and
wherein, depending on the evaluation for estimating the actual operating state, the control device (7) generates control commands to visualize an operating state change which deviates from a target operating state and/or to suggest and/or automatically adapt setting parameters, to be changed, of the soil cultivation device (1) and/or of the vehicle.

18. The agricultural system according to claim 17,
wherein the first sensor device (8) is an imaging and/or optical sensor system (8a, 8b), and/or
wherein the first sensor device (8) is arranged in a position above the carrier frame (2) so that its detection area is directed at or can be aligned with the soil (17) in order to detect a space located between the tools (3) arranged at a distance from one another on the carrier frame (2).

19. The agricultural system according to claim 17,
wherein the first sensor device (8) is set up to detect a material volume distribution (18) in a working area of the soil cultivation device (1).

20. The agricultural system according to claim 17,
wherein the control device (7) is set up to divide the material volume into different categories by evaluating the data provided by the first sensor device (8).

21. The agricultural system according to claim 17,
wherein the control device (7) is set up to determine the material volume (16) moved by at least one of the tools (3) by establishing a difference between a material flow speed and the actual speed of the soil cultivation device (1), the vehicle, or the agricultural system.

22. The agricultural system according to claim 17,
wherein the second sensor device (9) is set up to determine a speed of at least one component (4, 5) of the soil cultivation device (1) rotating upon contact with the soil.

23. The agricultural system according to claim 22,
wherein, to determine the actual speed of the soil cultivation device (1),
at least one speed sensor (12) is arranged on the at least one component (4, 5) of the soil cultivation device (1) rotating upon contact with the soil and/or
a position locating sensor (13) is arranged on the soil cultivation device (1).

24. The agricultural system according to claim 22,
wherein the control device (7) is set up to determine the actual speed of the soil cultivation device (1) to receive a driving speed of the vehicle.

25. The agricultural system according to claim 17, further comprising
a force-measuring sensor device for estimating changes in a force transmitted by the tools (3) to the soil (17) and/or from the vehicle to the soil cultivation device (1).

26. The agricultural system according to claim 17,
wherein at least one threshold value for a speed difference is stored in the control device (7), upon exceeding of which the control device (7) detects an impending or existing blockage.

27. The agricultural system according to claim 17,
wherein a change in a tensile force transmitted from the soil cultivation device (1) to the soil (17) is detectable by monitoring a hydraulic pressure in a cylinder of a hydraulic overload protection device of the soil cultivation device (1).

28. The agricultural system according to claim 17,
wherein a change in a tensile force transmitted from the soil cultivation device (1) to the soil (17) is detectable by force-measuring sensors arranged on the tools (3) which can be brought into engagement with the soil (17).

29. The agricultural system according to claim 17,
wherein the vehicle can be operated autonomously.

30. A method for operating an agricultural system comprising
a soil cultivation device (1),
a vehicle for moving and driving the soil cultivation device (1), and
a control device (7) with which the soil cultivation device (1) is actuated,
wherein the soil cultivation device (1) has tools (3) which are arranged on a carrier frame (2) and are brought into engagement with a soil (17) to be cultivated,
the method comprising:
estimating a material volume (16) moved by at least one of the tools (3) in relation to a working width of the soil cultivation device (1) by a first sensor device (8) arranged on the soil cultivation device (1),
estimating a speed difference between the soil cultivation device (1) and the material volume (16) by a second sensor device (9) arranged on the soil cultivation device (1) and detecting an actual speed,
receiving and evaluating data generated by the first sensor device (8) and the second sensor device (9) by the control device (7) to estimate an actual operating state of the soil cultivation device (1), and
generating, depending on the evaluation, control commands by the control device (7) in order to visualize an operating state change which deviates from a target operating state and/or to specify and/or automatically make changes to setting parameters of the soil cultivation device (1) and/or of the vehicle.

31. The method according to claim 30,
wherein, when a soil cultivation process is recorded by the agricultural system, reference data for a speed of the material volume (16) moved by the tools (3) and an actual speed of the soil cultivation device (1) are initially determined and define a target operating state.

32. The method according to claim 30,
wherein changes in a force transmitted by the tools (3) to the soil and/or from the vehicle to the soil cultivation device (1) are estimated by an additional force-measuring sensor device.
